(19) United States
(12) Patent Application Publication
(10) Pub. No.: US 2006/0069848 A1
(43) Pub. Date: Mar. 30, 2006

(54) Flash emulation using hard disk

(76) Inventors: Rajeev K. Nalawadi, Folsom, CA (US); Dong Thai, Elk Grove, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/956,396

(22) Filed: Sep. 30, 2004

(51) Int. Cl. G06F 12/00

(52) U.S. Cl. 711/103; 711/112

(57) ABSTRACT

A device including a storage controller. A flash memory is connected to the storage controller. The flash memory to store flash memory data. A processing unit is connected to the storage controller. The processing unit to generate memory commands. A volatile memory is connected to the processing unit. A non-volatile memory is connected to the storage controller. The non-volatile memory to retain the flash memory data. A process to perform memory commands on the flash memory data retained in the non-volatile memory.

### BACKGROUND

1. Field

This invention is generally related to non-volatile memory, and more particularly related to flash memory emulation using a hard drive.

2. Description of the Related Art

Non-volatile memory is a type of memory that can retain data and information without needing a power source applied. Typically this type of memory is referred to as “flash” memory or electrically erasable programmable read only memory (EEPROM). Flash memory is used in various types of devices, such as personal computers (PCs), notebook computers, personal digital assistants (PDAs), cellular telephones, etc. Critical information or data is typically stored on the flash memory, such as a basic input/output system (BIOS). Most flash memories only guarantee a limited number of erase and re-write cycles. Typically, only 10,000 cycles are guaranteed by most of the manufacturers.

With flash memory, data can be written in bytes and erased in blocks of memory. The blocks of memory typically vary between vendors and can range from 256 bytes to 1 Mbyte in size. FIG. 1 illustrates an exemplar flash memory structure 100. Block 105 contains a BIOS boot block. Block 110 contains BIOS initialization code. Block 115 contains a BIOS runtime library. Block 120 contains an advanced configuration and power interface (ACPI) system management BIOS (SMBIOS). Blocks 125 and 130 contain temporary blocks 1 and 2, respectively. Block 135 contains the last temporary block N, where N is a specific number depending on the size of the flash memory.

Some platform architectures use a limited number of flash memory blocks as additional memory space, or “scratch” space. These blocks can be considered as cache memory for frequently used data. This in turn allows for an efficient usage of the available flash space. The flash memory size, however, is very limited. And, the more the flash memory is read from and written to, the shorter the life span of the flash memory.

### BRIEF DESCRIPTION OF THE DRAWINGS

Embodiments are illustrated by way of example and not by way of limitation in the figures of the accompanying drawings in which like references indicate similar elements. It should be noted that references to “an” embodiment in this disclosure are not necessarily to the same embodiment, and they mean at least one.

FIG. 1 illustrates a basic flash memory structure.

FIG. 2 illustrates embodiment having a flash memory emulation command process.

FIG. 3 illustrates another embodiment coupled with another non-volatile memory.

FIG. 4 illustrates association between flash memory and a different type of non-volatile memory.

FIG. 5 illustrates a flash memory command data structure of an embodiment.

FIG. 6A illustrates an embodiment disposed in a cellular telephone.

FIG. 6B illustrates an embodiment disposed in a personal digital assistant (PDA).

FIG. 6C illustrates an embodiment disposed in a notebook computer.

FIG. 6D illustrates an embodiment disposed in a digital camera.

FIG. 7 illustrates a process of an embodiment.

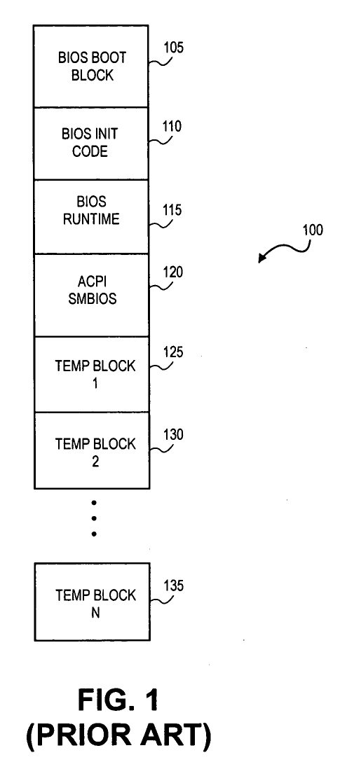

### DETAILED DESCRIPTION

The embodiments discussed herein generally relate to flash memory emulation on another non-volatile memory. Referring to the figures, exemplary embodiments will now be described. The exemplary embodiments are provided to illustrate the embodiments and should not be construed as limiting the scope of the embodiments.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

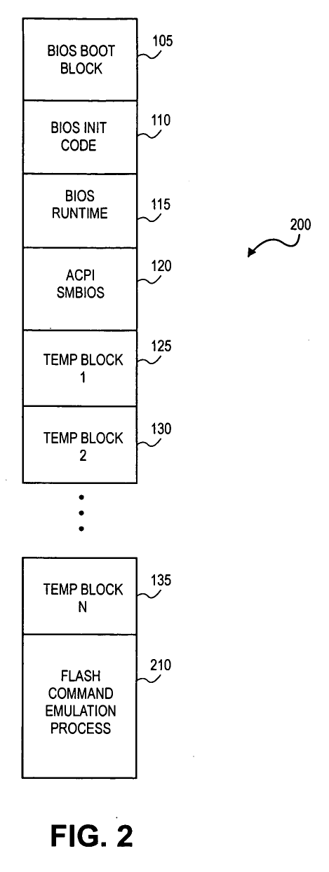

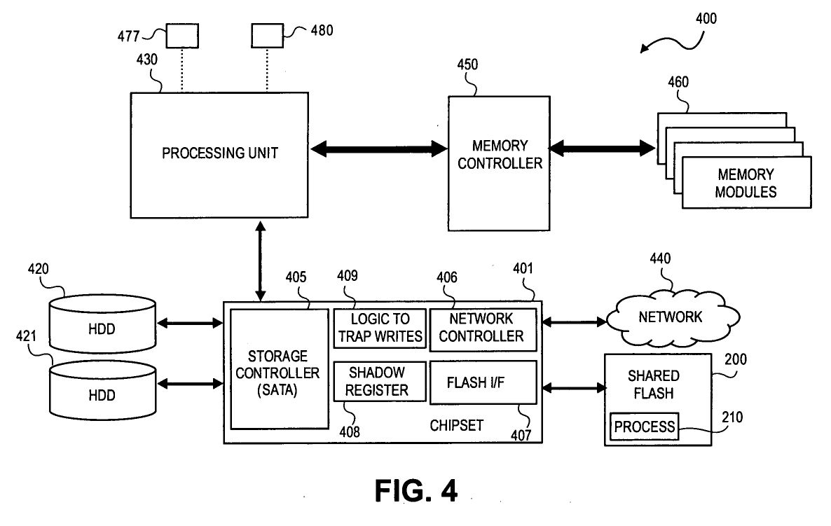

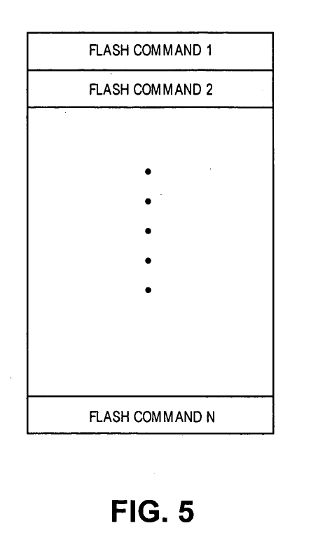

FIG. 2 illustrates an embodiment having a flash memory command emulation process 210. Flash memory emulation process 210 monitors flash memory commands generated by an external processing unit (see FIG. 4) and emulates flash memory commands to write to and read from another non-volatile external memory (see FIG. 4). In one embodiment, the external non-volatile memory is a hard disk drive (HDD).

Flash memory command emulation process 210 intercepts (traps on) generated flash memory commands from processing unit 430 (see FIG. 4). The types of commands to be intercepted are set forth below. A read data byte command intercepts accesses to scratch blocks and transfers data from a non-volatile memory (e.g., HDD 420 or 421 of FIG. 4) prior to completing the transfer. A write enable command prepares the file system on a non-volatile memory (e.g., HDD 420 or 421) for a write operation. A write disable command is an indication to flash memory command emulation process 210 that a write operation has completed. It should be noted that flash memory command emulation process is run by processing unit 430, chipset 401 or storage controller 405.

A read status register command updates a shadow register of flash memory 200 with current states of flash memory 200 read status register (not shown). Shadow register 408 is updated for busy, failure, success, etc. states. A write status register command monitors a write command to ensure whether a certain block of data needs to be protected on the non-volatile memory (e.g., HDD 420 or HDD 421) from an erase and/or page/block instructions.

A page/block program command monitors a bulk and sector erase command and address block (page/block) to ensure that the file system associated with this area on the non-volatile memory (e.g., HDD 420 or HDD 421) also gets modified. A bulk erase command indicates to flash memory command emulation process 210 that the entire flash memory is being erased, therefore, the file system associated with this temporary sector on the non-volatile memory (e.g., HDD 420 or HDD 421) needs to be re-established. A sector erase command indicates to flash memory command emulation process 210 that a sector in flash memory 200 is being erased. Therefore, the file system associated with the temporary sector on the non-volatile memory (e.g., HDD 420 or HDD 421) needs to be re-established.

Enter power-down, release from power-down, and read electronic signature/device identification (ID) commands update the flash memory shadow register state with current status.

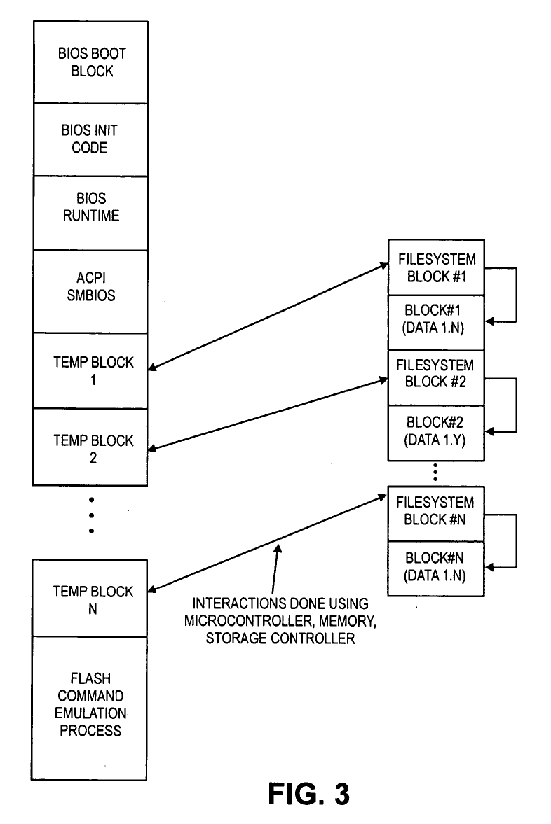

FIG. 3 illustrates the association between flash memory 200 and another non-volatile memory, such as HDD 420 or HDD 421. When flash memory command emulation process 210 determines a flash command has been generated by an external processing unit (see FIG. 4) flash memory command emulation process 210 performs the command on the non-volatile memory. Storage blocks on the non-volatile memory retain the information/data from flash memory 200.

FIG. 4 illustrates an embodiment including device 400. Device 400 includes chipset 401. Chipset 401 includes storage controller 405, network controller 406 connected to a network 440 (e.g., a wide area network (WAN), a local area network (LAN), Internet, etc.), flash memory interface 407, flash memory shadow register 408 and logic 409 to monitor flash memory write commands generated by processing unit 430. In one embodiment storage controller 405 is a serial advanced technology attachment (SATA) device. Also included in device 400 is flash memory 200. Flash memory 200 retains critical information and/or data and other information and/or data. In one embodiment, flash memory command emulation process 210 is disposed in storage controller 405 instead of flash memory 200. In one embodiment process 210 is implemented as microcode within chipset 401.

In one embodiment, flash memory 200 includes flash memory command emulation process 210. Processing unit 430 is connected to storage controller 405. Processing unit 405 generates flash memory commands, which are monitored/intercepted by flash memory command emulation process 210. In one embodiment, processing unit 430 is a low power (e.g., battery operated, such as a cellular telephone, a personal digital assistant (PDA), etc.) chipset and includes a microcontroller for generating flash memory commands.

In one embodiment, device 400 includes memory controller 450 that is connected to processing unit 430 and volatile memory modules 460. Volatile memory modules 460 can be any volatile memory device, such as a random access memory (RAM), cache memory, etc. In one embodiment, flash memory command emulation process 210 may be software residing in at least one of the volatile memory modules 460.

In one embodiment, non-volatile memory 420 is connected to storage controller 405. In another embodiment, another non-volatile memory 421 is connected to storage controller 405. Non-volatile memory 420 and 421 retains flash memory data in its file system. Flash memory command emulation process 210 emulates flash memory commands to store data to, and to retrieve data from, non-volatile memory 420/421.

In one embodiment, a cache memory is connected to the memory controller. In another embodiment, flash memory command emulation process 210 is disposed in the cache memory instead of flash memory 200.

In one embodiment, device 400 includes a display 470 and a user interface 480. Display 470 can be any type of display, such as a PDA display, a cellular telephone display, a notebook computer display, a digital camera display, a personal computer (PC) display, etc. User interface 480 can be any type of user interface, such as a keypad from a PDA, cellular telephone, notebook computer or PC, a resistive digitizer (i.e., touchscreen), a pointing device, a computer mouse, a joystick, etc. Device 400 can be disposed in low power devices, such as a cellular telephone, a PDA, a digital camera, a notebook computer, and a PC. In one embodiment flash memory command emulation process 210 avoids reading data from the flash memory by reading either redundant data (i.e., critical data/information) or non-redundant data/information from non-volatile memory 420.

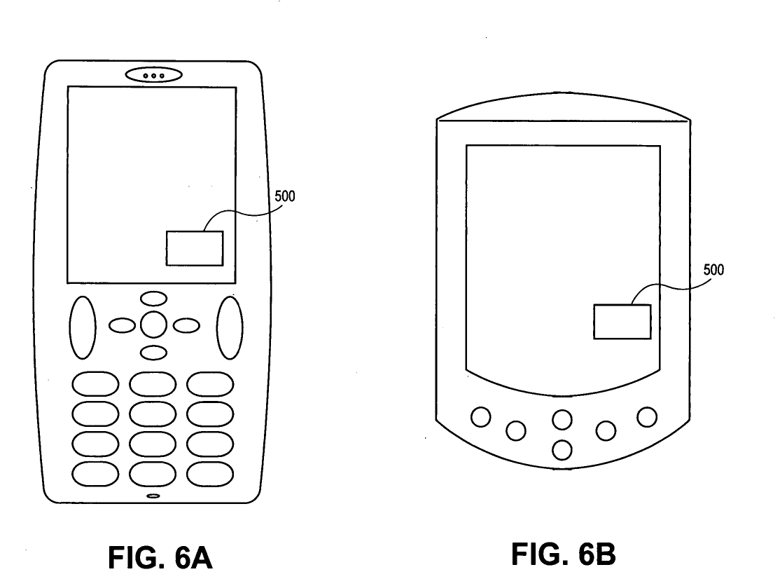

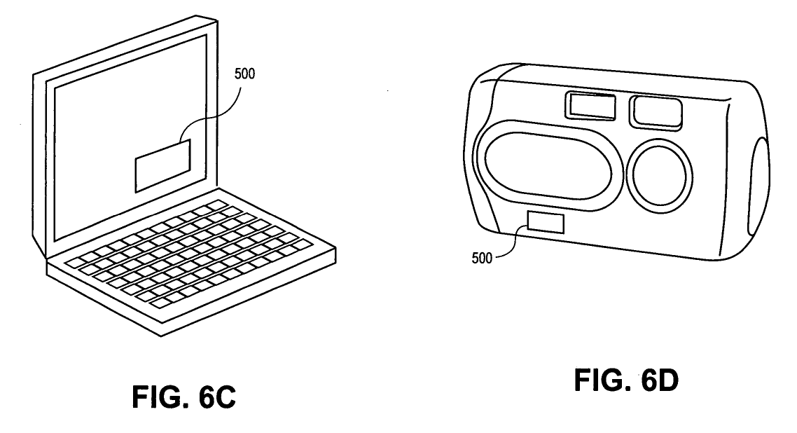

FIG. 6A illustrates device 400 disposed in a cellular telephone. FIG. 6B illustrates device 400 disposed in a PDA. FIG. 6C illustrates device 400 disposed in a notebook computer. FIG. 6D illustrates device 400 disposed in a digital camera.

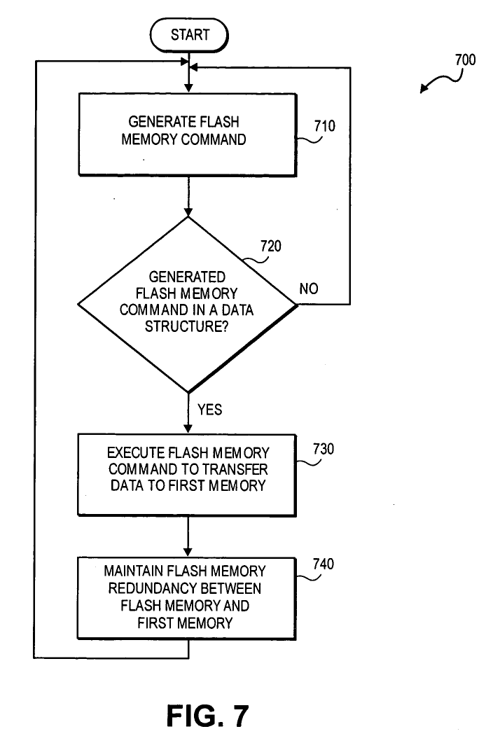

FIG. 7 illustrates an embodiment having a process illustrated in block form. Process 700 begins with block 710, which generates a flash memory command. The flash memory command is generated by a device, such as a microcontroller of processing unit 430. After a flash memory command is generated, block 720 determines whether the flash memory command is in a stored data structure, such as a table, containing certain flash memory commands, such as the intercepted commands asserted above. If it is determined that the generated flash memory command is not in the data structure, process 700 continues to the start and begins again once a flash memory command is generated by block 710.

If it is determined that a flash memory command is in the data structure, process 700 continues with block 730. In block 730, the flash memory command is emulated by a process, such as process 210, and the emulated command is executed. The executed emulated flash memory command transfers data/information between a flash memory, such as flash memory 200, and a first memory, such as non-volatile memory 420/421. After block 730 is complete, process 700 continues with block 740. Block 740 maintains critical data/information redundancy between the flash memory and the non-volatile memory.

In another embodiment, a file system in the non-volatile memory is associated with each block in the flash memory (see FIG. 3). In this embodiment, the flash memory commands are monitored before determining whether the flash memory command is in the data structure during block 720. In one embodiment, the non-volatile memory (i.e. first memory) is a hard disk drive (HDD). The emulated flash memory commands can be any of a read command, a write command, an erase command, a read status command, a write status command and an operational status command.

In another embodiment, a machine-accessible medium contains instructions that, when executed, cause a machine, such as a computer, to transmit flash memory commands, monitor flash memory commands, lookup the flash memory commands in a data structure (e.g., a table), and determine if transmitted flash memory commands are stored in the data structure, maintain critical content redundancy between a flash memory and a first memory (i.e., non-volatile memory) if the transmitted flash memory commands are determined to be stored in the data structure. In another embodiment, the machine is caused to emulate the flash memory commands and allocate a flash memory to store cache memory data.

In one embodiment, the machine is, for example, a cellular telephone, a personal desk assistant (PDA), a digital camera, a notebook computer, or a personal computer (PC). In other embodiments, the machine can be any desired type of machine containing appropriate components to execute the instructions.

In one embodiment, the instructions causing the machine to emulate include emulating a read command, a write command, an erase command, a read status command, a write status command or an operational status command.

The above embodiments increase the storage capacity of devices containing flash memory and other non-volatile memory devices. Since flash memory is associated with low power the above embodiments are well suited for out of band (OOB) manageability applications and devices that need to conserve power, such as cellular telephones. Devices containing hard disks in small form factors (SFF) for the non-volatile memory can be used with the above embodiments to increase the flash memory storage capability by using the non-volatile memory as flash memory.

The above embodiments help prevent early degradation of flash memory as non-volatile memory is used in conjunction with emulated flash memory commands and especially erase operations. In one embodiment, code/data/stack instructions are separated and the emulation handles data/stack instructions. The use of non-volatile memory expands flash memory storage and is transparent to the user. With devices, such as cellular telephones, more and more memory is required to store data streams, pictures, moving pictures, music and other multimedia. The above embodiments can use the “virtual” flash memory as a temporary storage device to cache memory required for OOB manageability, cellular telephone data streams, Java™ applet execution, etc.

Some embodiments can also be stored on a device or machine-readable medium and be read by a machine to perform instructions. The machine-readable medium includes any mechanism that provides (i.e., stores and/or transmits) information in a form readable by a machine (e.g., a computer, PDA, cellular telephone, etc.). For example, a machine-readable medium includes read-only memory (ROM); random-access memory (RAM); magnetic disk storage media; optical storage media; flash memory devices; biological electrical, mechanical systems; electrical, optical, acoustical or other form of propagated signals (e.g., carrier waves, infrared signals, digital signals, etc.). The device or machine-readable medium may include a micro-electromechanical system (MEMS), nanotechnology devices, organic, holographic, solid-state memory device and/or a rotating magnetic or optical disk. The device or machine-readable medium may be distributed when partitions of instructions have been separated into different machines, such as across an interconnection of computers or as different virtual machines.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. An apparatus comprising:
a storage controller;
a flash memory coupled to the storage controller, the flash memory to store flash memory data,
a processing unit coupled to the storage controller, the processing unit to generate flash memory commands;
a volatile memory coupled to the processing unit;
a non-volatile memory coupled to the storage controller, the non-volatile memory to retain the flash memory data; and
a process to perform memory commands on the flash memory data retained in non-volatile memory.

2. The apparatus of claim 1, wherein the non-volatile memory is a hard disk drive (HDD).

3. The apparatus of claim 1, wherein the storage controller is a serial advanced technology attachment (SATA) controller.

4. The apparatus of claim 1, the process to emulate flash memory commands to store data to, and to retrieve data from, the non-volatile memory.

5. The apparatus of claim 1, a cache memory coupled to the memory controller, wherein the process is disposed in the cache memory.

6. The apparatus of claim 4, wherein the process is disposed in the flash memory.

7. A system comprising:
a first processor;
a memory controller coupled to the first processor, the first processor to generate flash memory commands;
a display coupled to the first processor;
a second processor coupled to the first processor;
a first memory coupled to the second processor,
a flash memory coupled to the second processor, and
a process to maintain redundant content between the flash memory and the first memory.

8. The system of claim 7 wherein the system is disposed in one of a cellular telephone, a personal desk assistant (PDA), a digital camera, a notebook computer, and a personal computer (PC).

9. The system of claim 7 wherein the process is to reduce reading of data from the flash memory.

10. The system of claim 7 the first memory is a hard disk drive (HDD) and a storage controller coupled to the second processor is a serial advanced technology attachment (SATA) controller.

11. The system of claim 7 wherein one of the flash memory and a second memory includes the process, and the process to monitor flash memory commands issued by the memory controller.

12. The system of claim 11 wherein the process emulates flash memory read and write commands.

13. A method comprising:
generating at least one flash memory command;
determining if the at least one generated flash memory command is stored in a data structure;
emulating the execution of the at least one generated flash memory command to store flash memory data to a first memory if the at least one generated flash memory command is determined to be stored in the data structure, and
maintaining critical content redundancy between the flash memory and the first memory.

14. The method of claim 13, further comprising:
associating a file system in the first memory with each of a plurality of blocks in the flash memory;
monitoring the at least one flash memory command; and
emulating the at least one flash memory command.

15. The method of claim 13, the first memory is a hard disk drive (HDD).

16. The method of claim 14, wherein emulating comprises:
emulating one of a read command, a write command, an erase command, a read status command, a write status command and an operational status command.

17. A machine-accessible medium containing instructions that, when executed, cause a machine to:
monitor flash memory commands;
determine if a transmitted flash memory command is stored in a data structure;
maintain critical content redundancy between a flash memory and a second memory if the transmitted flash memory commands are determined to be stored in the data structure.

18. The machine-accessible medium of claim 17, further containing instructions that, when executed, cause a machine to:
emulate the flash memory commands; and
allocate a flash memory to store cache memory data.

19. The machine-accessible medium of claim 17, wherein the machine-accessible medium is disposed in one of a cellular telephone, a personal desk assistant (PDA), a digital camera, a notebook computer, and a personal computer (PC).

20. The machine-accessible medium of claim 17, wherein the instruction to emulate comprises:
emulating one of a read command, a write command, an erase command, a read status command, a write status command and an operational status command.
